(19) United States
(12) Patent Application Publication
(10) Pub. No.: US 2026/0243203 A1
(43) Pub. Date: Aug. 20, 2026

(54) TURBO-EXPANDER OVERSPEED PROTECTION

(71) Applicant: NET Power LLC, Durham, NC (US)

(72) Inventors: Scott Thomas Martin, Salt Lake City, UT (US); Stefan Tschirren, Staufen (CH); Nathan Davis, Kaysville, UT (US)

(73) Assignee: NET Power LLC, Durham, NC (US)

(21) Appl. No.: 19/457,462

(22) Filed: Jan. 23, 2026

Related U.S. Application Data
(60) Provisional application No. 63/750,074, filed on Jan. 27, 2025.

(51) Int. Cl. F02C 9/20; F01D 15/10; F01D 17/06; F01D 25/12; F02C 9/18

(52) U.S. Cl. CPC F02C 9/20; F01D 15/10; F01D 17/06; F01D 25/12; F02C 9/18; F05D 2270/021; F05D 2270/3015

(57) ABSTRACT

Methods and systems for controlling speed of a turboexpander receiving a working fluid from an oxy-fuel combustor. A first valve modulates flow of a working fluid into the combustor between a minimum and a maximum working fluid flow rate. A first pipe between the first valve and the combustor has a first volume to hold the working fluid at an inlet pressure. A discharge chamber receives a fluid, the discharge chamber being at an outlet pressure, wherein the inlet pressure is greater than the outlet pressure. A diverter valve connects the pipe and the discharge chamber when the diverter valve is open. A controller detects a condition where the turboexpander accelerates above a maximum acceleration, a maximum speed, or both, and opens the diverter valve and closes the first valve upon detection of the condition, thereby reducing a pressure differential across the turboexpander.

### CROSS-REFERENCE TO RELATED APPLICATIONS

This application claims the benefit of U.S. Provisional Patent Application No. 63/750,074, filed Jan. 27, 2025 and entitled “Turbo-Expander Overspeed Protection,” the entire contents of which are incorporated by reference herein.

### TECHNICAL FIELD

The present disclosure relates to systems and methods for protecting a turbo-expander from overspeed during a load rejection event, for example in oxy-fuel combustion systems.

### BACKGROUND

Combustion systems, including the Allam Cycle, may utilize a carbonaceous fuel, an oxidant stream, and a recycled carbon dioxide stream to produce energy. The oxidant and recycle streams require energy inputs to produce. For certain details of the Allam Cycle, see U.S. Pat. No. 8,596,075, the entire contents of which are incorporated by reference herein.

### SUMMARY

In some examples, the disclosure provides a system for controlling a speed of a turbo-expander receiving a working fluid from an oxy-fuel combustor. The system includes a first valve to modulate a flow, through a first port, of the working fluid into the oxy-fuel combustor between a minimum working fluid flow rate and a maximum working fluid flow rate. The system includes a first pipe between the first valve and the first port, the first port comprising a first volume to hold the working fluid at an inlet pressure of the oxy-fuel combustor. The system includes a discharge chamber to receive at least a portion of the working fluid, the discharge chamber at an outlet pressure lower than the inlet pressure. The system includes a first diverter valve to connect the first pipe and the discharge chamber when the first diverter valve is open. The system includes a controller to, (i) detect a first condition where the turbo-expander accelerates above a maximum acceleration, above a maximum speed, or above both a maximum acceleration and above a maximum speed, and, (ii) responsive to detecting the first condition, reduce a pressure differential across the turbo-expander by sending an open signal to open the diverter valve and sending a close signal to close the first valve.

In some examples, the system includes the turbo-expander and a generator, wherein the turbo-expander is to drive the generator.

In some examples, the system includes the controller to control the speed of the turbo-expander during a load rejection event.

In some examples, the system includes a house load to receive a first portion of a power output of the generator during the load rejection event.

In some examples, the system includes a load bank to receive a second portion of the power output of the generator during the load rejection event.

In some examples, the system includes a backup first diverter valve to provide redundancy to the first diverter valve.

In some examples, the system includes a first pre-block diverter valve connected upstream of the first valve to the discharge chamber, the open signal further to open the first pre-block diverter valve as the first valve is closed.

In some examples, the system includes a second pre-block diverter valve connected upstream of the first valve to a low-pressure chamber, the open signal further to open the second pre-block diverter valve as the first valve is closed.

In some examples, the system includes a first rupture disc between the first pipe and the discharge chamber to rupture when the pressure differential exceeds a first safety limit.

In some examples, the controller is further to (iii) detect a second condition where the turbo-expander acceleration approaches the maximum acceleration, approaches the maximum speed, or approaches both the maximum acceleration and the maximum speed, and (iv) send a second signal to partially close the first valve, partially open the first diverter valve, or both partially close the first valve and partially open the diverter valve.

In some examples, the system includes a second valve to modulate a flow, through a second port, of fuel into the oxy-fuel combustor between a minimum fuel flow rate and a maximum fuel flow rate, a second pipe between the second valve and the second port, the second pipe comprising a second volume to hold the fuel at the inlet pressure, a second diverter valve to connect the second pipe and the discharge chamber when the second diverter valve is open, the open signal further to open the second diverter valve and the close signal further to close the second valve, thereby reducing the pressure differential.

In some examples, the system includes a backup second diverter valve to provide redundancy to the second diverter valve.

In some examples, the system includes a third pre-block diverter valve connected upstream of the second valve to the discharge chamber, the open signal further to open the third pre-block diverter valve as the second valve is closed.

In some examples, the system includes a fourth pre-block diverter valve connected upstream of the second valve to a low-pressure chamber, the open signal further to open the fourth pre-block diverter valve as the second valve is closed.

In some examples, the system includes a second rupture disc between the second pipe and the discharge chamber to rupture when the pressure differential exceeds a second safety limit.

In some examples, the controller is further to (v) detect a third condition where the turbo-expander acceleration approaches the maximum acceleration, approaches the maximum speed, or approaches both the maximum acceleration and the maximum speed, and (vi) send a third signal to partially close the second valve, partially open the second diverter valve, or to both partially close the second valve ad partially open the second diverter valve.

In some examples, the system includes a third valve to modulate a flow, through a third port, of an oxidant into the oxy-fuel combustor between a minimum oxidant flow rate and a maximum oxidant flow rate, a third pipe between the third valve and the third port, the third pipe comprising a third volume to hold the oxidant at the inlet pressure;
a third diverter valve to connect the third pipe and the discharge chamber when the third diverter valve is open, the open signal further to open the third diverter valve and the close signal further to close the second valve, thereby reducing the pressure differential.

In some examples, the system includes a backup third diverter valve to provide redundancy to the third diverter valve.

In some examples, the system includes a fifth pre-block diverter valve connected upstream of the third valve to the discharge chamber, the open signal further to open the fifth pre-block diverter valve as the third valve is closed.

In some examples, the system includes a sixth pre-block diverter valve connected upstream of the third valve to a low-pressure chamber, the open signal further to open the sixth pre-block diverter valve as the third valve is closed.

In some examples, the system includes a third rupture disc between the third piped connection and the discharge chamber to rupture when the pressure differential exceeds a safety limit.

In some examples, the system includes the controller to detect a fourth condition where the turbo-expander acceleration approaches the maximum acceleration, approaches the maximum speed, or both, and the controller to send a fourth signal to partially close the third valve, partially open the third diverter valve, or both partially close the third valve and partially open the third diverter valve.

In some examples, the discharge chamber is a post-turbo-expander volume.

In some examples, the discharge chamber is a pressure vessel.

In some examples, the system includes a pump to maintain the pressure vessel at a lower pressure than the inlet pressure before the controller detects the condition.

In some examples, the system includes a vent valve in fluid communication with a volume of the oxy-fuel combustor, the controller further to determine whether a rate of decrease of the pressure differential is insufficient, and responsive to determining that the rate of decrease of the pressure differential is insufficient, send a second open signal to the vent valve, the vent valve to vent the working fluid from the oxy-fuel combustor.

In some examples, the system includes a power-load imbalance detector to signal the controller, the controller further to send the open signal and the close signal if a detected imbalance is above a threshold.

In some examples, the system includes instruments, virtual instruments, or both instruments and virtual instruments, to detect the condition.

In some examples, the system includes a slip stream valve to create a slip stream of the working fluid to bypass the first valve and cool the turbo-expander.

In some examples, the disclosure provide a method for controlling a speed of a turbo-expander receiving a working fluid from an oxy-fuel combustor. The method includes using a first valve to modulate a flow of the working fluid through a first pipe, into the oxy-fuel combustor between a minimum working fluid flow rate and a maximum working fluid flow rate. The method includes holding a volume of the working fluid at an inlet pressure in the first pipe. The method includes detecting a condition where the turbo-expander accelerates above a maximum acceleration, above a maximum speed, or above both a maximum acceleration and a maximum speed. Responsive to detecting the condition, the method includes reducing a pressure differential across the turbo-expander using operations including, (i) sending an open signal to open a first diverter valve between the first pipe and a discharge chamber at an outlet pressure lower than the inlet pressure, and, (ii) sending a close signal to close the first valve.

In some examples, the method includes driving a generator by the turbo-expander.

In some examples, the method includes controlling the speed of the turbo-expander during a load rejection event.

In some examples, the method includes receiving a first portion of a power output of the generator in a house load during the load rejection event.

In some examples, the method includes receiving a second portion of the power output of the generator in a load bank during the load rejection event.

In some examples, the method includes opening a backup first diverter valve by a backup open signal when the first diverter valve fails.

In some examples, a first pre-block diverter valve is connected upstream of the first valve to the discharge chamber, and the method includes opening the first pre-block diverter valve by a backpressure-prevention open signal as the first valve is closed.

In some examples, a second pre-block diverter valve is connected upstream of the first valve to a low-pressure chamber, and the method includes opening the second pre-block diverter valve by a backpressure-prevention open signal from the controller as the first valve is closed.

In some examples, a rupture disc is between the first pipe and the discharge chamber, the rupture disc rupturing when the pressure differential exceeds a safety limit.

In some examples, the method includes detecting a second condition where the turbo-expander acceleration approaches the maximum acceleration, the turbo-expander approaches the maximum speed, or both the turbo-expander acceleration approaches the maximum acceleration and the turbo-expander approaches maximum speed, and sending a first signal to partially close the first valve, partially open the first diverter valve, or both partially close the first valve and partially open the first diverter valve.

In some examples, the method includes using a second valve to modulate a flow of a fuel through a second pipe, into the oxy-fuel combustor between a minimum fuel flow rate and a maximum fuel flow rate, holding a volume of the fuel at the inlet pressure in the second pipe, and responsive to detecting the condition, (i) sending the open signal to open a second diverter valve between the second pipe and the discharge chamber, the second pipe at the inlet pressure, and, (ii) sending the close signal to close the second valve.

In some examples, the method includes opening a backup second diverter valve by the backup open signal when the second diverter valve fails.

In some examples, a third pre-block diverter valve is connected upstream of the second valve to the discharge chamber, and the method includes opening the third pre-block diverter valve by the backpressure-prevention open signal as the second valve is closed.

In some examples, a fourth pre-block diverter valve is connected upstream of the second valve to a low-pressure chamber, and the method includes opening the fourth pre-block diverter valve by the backpressure-prevention open signal as the second valve is closed.

In some examples, a rupture disc is between the second pipe and the discharge chamber, and the rupture disc ruptures when the pressure differential exceeds a safety limit.

In some examples, the second signal partially closes the second valve, partially opens the second diverter valve, or both partially closes the second valve and partially opens the second diverter valve.

In some examples, the method includes using a third valve to modulate a flow of an oxidant through a third pipe, into the oxy-fuel combustor, between a minimum oxidant flow rate and a maximum oxidant flow rate, holding a volume of the oxidant stream at the inlet pressure in the third pipe, wherein a third diverter valve connects the third pipe to the discharge chamber, and responsive to detecting the condition, (i) sending an open signal to open a third diverter valve connecting the third pipe to the discharge chamber, the third pipe at the inlet pressure, and, (ii) sending a close signal via the controller to close the third valve.

In some examples, the method includes opening a backup third diverter valve by the backup open signal when the third diverter valve fails.

In some examples, a fifth pre-block diverter valve is connected upstream of the third valve to the discharge chamber, and the method includes opening the fifth pre-block diverter valve by a backpressure-prevention open signal as the third valve is closed.

In some examples, a sixth pre-block diverter valve is connected upstream of the third valve to a low-pressure chamber, and the method includes opening the sixth pre-block diverter valve by the backpressure-prevention open signal as the third valve is closed.

In some examples, a rupture disc is between the third pipe and the discharge chamber, the rupture disc rupturing when the pressure differential exceeds a safety limit.

In some examples, the method includes the second signal partially closing the third valve, partially opening the third diverter valve, or both partially closing the third valve and partially opening the third diverter valve.

In some examples, the discharge chamber is a post-turbo-expander volume.

In some examples, the discharge chamber is a pressure vessel.

In some examples, the method includes maintaining the pressure vessel at a lower pressure than the first piped connection by a pump before detecting the condition.

In some examples, a vent valve is in fluid communication with the oxy-fuel combustor volume, the method including determining a rate of decrease of the pressure differential is insufficient, sending an emergency open signal to open the vent valve, and venting the combusting gas from the combustor via the vent valve.

In some examples, the method includes sending a power-load imbalance signal from a power-load imbalance detector, responding to a detected imbalance above a threshold by sending the open signal and the close signal.

In some examples, the method includes detecting the condition with instruments, virtual instruments, or both instruments and virtual instruments.

In some examples, the method includes a slip stream of the working fluid, and further comprising bypassing the working fluid valve with the slip stream, and using the slip stream to cool the turbo-expander.

In some examples, the disclosure provides a system for preventing overspeed of a turbo-expander. The system includes an oxy-fuel combustor system with a first pre-combustor volume containing a working fluid stream, a second pre-combustor volume containing an oxidant stream, and a third pre-combustor volume containing a fuel stream, all connected to a combustor volume containing a combusting gas stream, the combustor volume connected to a turbo-expander volume containing a hot working fluid stream, wherein the oxy-fuel combustor system drives rotation of a shaft to drive a generator, wherein the pre-combustor volume is at a greater pressure than a dump volume, and wherein the dump volume is enclosed. The system includes a working fluid cut-off valve that controls flow of the working fluid stream into the first pre-combustor volume. The system includes an oxidant cut-off valve that controls flow of the oxidant stream into a second pre-combustor volume. The system includes a fuel cut-off valve that controls flow of the fuel stream into a third pre-combustor volume. The system includes a first bypass valve that controls flow of a working fluid vent stream from the first pre-combustor volume into the dump volume. The system includes a controller that detects a load rejection and sends a close signal to the working fluid cut-off valve, the fuel cut-off valve, and the oxidant cut-off valve to close, and sends an open signal to the first bypass valve to open such that the working fluid is vented from the first pre-combustor volume to the dump volume, reducing a rotation speed of the shaft.

In some examples, the disclosure provides a system for preventing overspeed of a turbo-expander. The system includes an oxy-fuel combustor with a combustion output that provides a working fluid to a turbo-expander, where the combustor further has a fuel stream input port, an oxidant stream input port, and a working fluid stream input port, where each of the fuel stream, the oxidant stream, and the working fluid stream ports are connected to a corresponding valve, such that the fuel stream valve, the oxidant stream valve, and the working fluid stream valve can modulate the flow of the respective fuel, oxidant, and working fluid streams entering the respective port between a minimum and maximum flow rate, and where a first piped connection between the working fluid stream valve and the working fluid stream port holds a volume of the working fluid stream, and where a second piped connection between the fuel stream valve and the fuel stream port holds a volume of the fuel stream, and where a third piped connection between the oxidant stream valve and the oxidant stream port holds a volume of the oxidant stream, and wherein a pressure of the working fluid in the first piped connection prior to entry into the working fluid port is higher than a pressure at a discharge chamber. The system includes a diverter valve between the first piped connection and the discharge chamber where a controller detects a condition where the turbo-expander accelerates above a maximum acceleration, a maximum speed, or both, and the controller opens the diverter valve as the working fluid stream valve is closed, thereby reducing a pressure differential across the turbo-expander.

In some examples, the present disclosure provides a method for preventing overspeed of a turbo-expander powered generator during load rejection. The method includes passing a working fluid stream through a working fluid cut-off valve, through a first pre-combustor volume, and into a combustor volume. The method includes passing an oxidant stream through an oxidant cut-off valve, through a second pre-combustor volume, and into the combustor volume. The method includes passing a fuel stream through a fuel cut-off valve, through a third pre-combustor volume, and into the combustor volume. The method includes mixing and combusting the working fluid stream, the oxidant stream, and the fuel stream in the combustor volume to create a hot working fluid stream. The method includes driving a turbine with the hot working fluid stream, the turbine driving a shaft at a rotation speed, the shaft driving a generator, and the generator generating electrical power. The method includes detecting a load rejection of the electrical power and sending an upset signal to a controller. The method includes sending a close signal from the controller to the working fluid cut-off valve, the oxidant cut-off valve, and the fuel cut-off valve. The method includes sending an open signal from the controller to a first bypass valve, the first bypass valve connecting the first pre-combustor volume to a dump volume, wherein the dump volume is at a lower pressure than the combustor volume. The method includes venting the working fluid stream through the first bypass valve into the dump volume, reducing the rotation speed.

In some examples, the present disclosure provides a method for preventing overspeed of a turbo-expander. The method includes providing an oxy-fuel combustor comprising a combustion output providing a working fluid to a turbo-expander, the combustor further comprising a fuel stream input port, an oxidant stream input port, and a working fluid stream input port. The method includes modulating a flow of a fuel stream through the fuel stream input port via a fuel stream valve. The method includes modulating a flow of an oxidant stream through the oxidant stream input port via an oxidant stream valve. The method includes modulating a flow of a working fluid stream through the working fluid stream port via a working fluid stream valve, where the flows of the fuel stream, the oxidant stream, and the working fluid stream enter their respective port between a minimum and a maximum flow rate, and where a first piped connection between the working fluid stream valve and the working fluid stream port holds a volume of the working fluid stream, and where a second piped connection between the fuel stream valve and the fuel stream port holds a volume of the fuel stream, and where a third piped connection between the oxidant stream valve and the oxidant stream port holds a volume of the oxidant stream, wherein a pressure of the working fluid in the first piped connection prior to entry into the working fluid port is higher than a pressure at a discharge chamber. The method includes detecting a condition where the turbo-expander accelerates above a maximum acceleration, a maximum speed, or both, in a controller, The method includes sending a signal via the controller to the diverter valve to open and the working fluid stream valve to close, thereby reducing a pressure differential across the turbo-expander.

Further examples are provided in the drawings, detailed description, and claims.

### BRIEF DESCRIPTION OF DRAWINGS

The following drawings are provided to illustrate certain embodiments described herein. The drawings are merely illustrative and are not intended to limit the scope of the claims and are not intended to show every potential feature or embodiment that is claimed. The drawings are not necessarily drawn to scale; in some instances, certain elements of the drawing may be enlarged with respect to other elements of the drawing for purposes of illustration.

FIG. 1 is a process flow diagram showing an example system for controlling the speed of a turbo-expander receiving a working fluid from an oxy-fuel combustor.

FIG. 2 is a process flow diagram showing another example system for controlling the speed of a turbo-expander receiving a working fluid from an oxy-fuel combustor.

FIG. 3 is a process flow diagram showing another example system for controlling the speed of a turbo-expander receiving a working fluid from an oxy-fuel combustor.

FIG. 4 is a block diagram showing an example method for controlling the speed of a turbo-expander receiving a working fluid from an oxy-fuel combustor.

FIG. 5 is a block diagram showing an example method for controlling the speed of a turbo-expander receiving a working fluid from another oxy-fuel combustor.

FIG. 6 is a block diagram showing an example method for controlling the speed of a turbo-expander receiving a working fluid from another oxy-fuel combustor.

### DETAILED DESCRIPTION

The following description recites various aspects and embodiments of the subject matter disclosed herein. No particular embodiment is intended to define the scope of the present subject matter. Rather, the embodiments provide non-limiting examples of various compositions, and methods that are included within the scope of the claimed subject matter. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “about” and “approximately” mean within ±10% of the stated value, e.g., within ±5% of the stated value, or within ±2% of the stated value.

In some examples, the turboexpander (TEX) in an oxy-fuel combustion plant operates under significant upstream energy supply that includes a high pressure and high temperature CO₂ working fluid. Other high-pressure flows are added directly to the combustor in the form of high temperature oxidant (a mixture of O₂ and CO₂) and natural gas fuel (at approx. 550MWth). In some examples, during normal operation, this CO₂ working fluid mixes with combustion products downstream of the flame at a temperature of approximately 600° C. and a pressure above approximately 320 bara. The heat of reaction of the natural gas fuel and supplied oxygen adds additional energy to the bulk flow. In some examples, this results in a temperature of approximately 945° C. at a pressure of approximately 300 bara (considering combustor pressure losses) at the turboexpander (TEX) inlet. The flow then expands through the TEX at pressure ratios between 8-10, down to a design pressure of around 40 bara while producing approximately (430MWe) of gross power. Together, the combustor and turboexpander can be referred to as the oxy combustion turboexpander (OCTEX), with the spinning mechanical element of the OCTEX being or including the TEX.

In the ongoing example, the TEX is coupled to a generator via a rigid coupling. During normal operation the generator converts mechanical kinetic energy of the coupled train into electrical power through induction of the generator windings. Unlike traditional combustion turbines and akin to steam turbines, the TEX typically does not have compression stages on the common driveshaft. Instead, the compression is conducted separately in the cycle, upstream of the main heat exchange and CO₂ pumping steps. While this configuration allows for the cycle to produce power and capture CO₂ at low-cost and high efficiencies, it does mean that there is no other connected mechanical load on the TEX-Generator drivetrain to prevent overspeed in the event of a sudden change in load at the generator.

Continuing the example, between the OCTEX and the rest of the process cycle is the main process heat exchanger recuperator (HXR). The turboexpander pressure drop creates an upstream high-pressure and downstream low-pressure volume, each separately in communication with the hot end of the HXR. Between the recuperator sections lie the balance of plant (BOP) equipment, which removes water from the process, recompresses the CO₂, blends O₂ with CO₂ to create the oxidant stream, and then returns the two flows to the HXR. Within the HXR the recycle CO₂ stream is partially divided to provide secondary gas flow to the TEX. Meanwhile, fuel is separately added to the OCTEX via a dedicated and separate fuel supply system.

Practical considerations and tradeoffs of turbomachinery design and cost prevent workarounds, such as engineering equipment that can maintain speeds well beyond their rated conditions. In the case of the Allam cycle in the present example, the current overspeed limit is governed by the maximum rated design speed of the generator, which in one example is 120% of the rated condition (120%*3600 rpm=4320 rpm in 60 Hz or 120%* 3000 rpm=3600 rpm in 50 Hz). In this example, the conditions would require the installation of additional protection equipment to reduce the risk of overspeed as much as possible and eliminate the risk for specific scenarios.

These scenarios can broadly be described as load rejection scenarios. Example scenarios include, in order of roughly increasing severity of the TEX overspeed:
a partial load rejection or emergency shutdown of key facility auxiliary services, and/or
a generator protection trip or failure, and/or
an unplanned partial load rejection from the grid, and/or
an unplanned full grid load rejection, and/or
a severing of the TEX-generator coupling (which when occurring alone, may result in TEX-only overspeed).

As recognized by the present inventors, it can be helpful in load scenarios such as these to consider the quantity of the change in load and moment of inertia (MOI), the time interval of the loss, the ability to foresee the loss, as well as the end recovery state in the assessment.

Upstream potential energy, which in these examples is normally absorbed and converted to power at the generator through induction at the generator's windings, runs against an unloaded (load rejected) drivetrain with moment of inertia, Irot. In example scenarios listed above, except for the case where a severing of the TEX-generator coupling occurs alone, the Irot before and after the load rejection event is equal, with generator power replaced instead with rotational kinetic energy.

The present systems and methods control the speed of rotation of the turbo-expander in load rejection events, including instances when the turbo-expander accelerates above a maximum acceleration or passes a maximum speed. The examples that follow show the systems and methods for controlling the speed. With this control, risk of damage to the turbo-expander, the generator, or the shaft in a load rejection event are reduced or minimized.

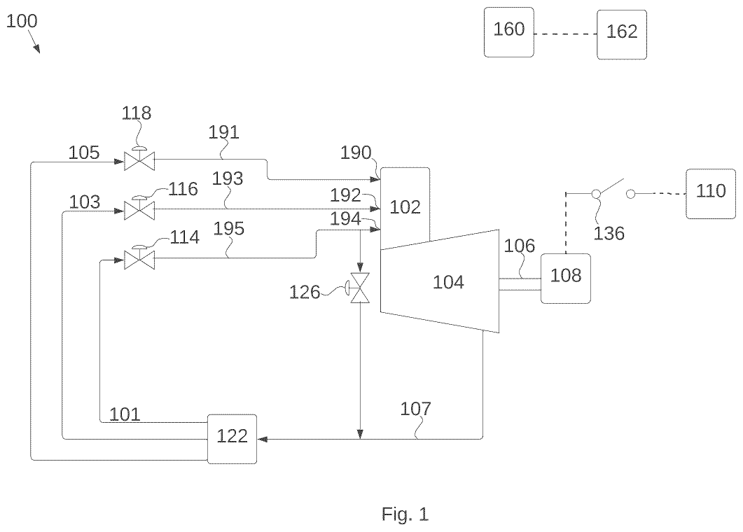

Now referring to FIG. 1, FIG. 1 is a process flow diagram showing an example system 100 for controlling the speed of a turbo-expander receiving a working fluid from an oxy-fuel combustor that may be used in some examples provided herein. This example is purely illustrative, and multiple other examples are envisioned or may be readily envisioned without undue experimentation.

In some examples, system 100 is an oxy-fuel combustion system for generating power. In the nonlimiting configuration illustrated in FIG. 1, system 100 includes a combustor 102, a turbo-expander 104, a shaft 106, a generator 108, a switch 136, a power consumer 110, the balance of the oxy-fuel combustion system 122, a controller 160, oxy-fuel combustion system instruments 162, a diverter valve 126, a working fluid valve 114, a fuel valve 116, and an oxidant valve 118. The last three will be referred to as the first, second, and third valves, respectively. In normal operations, working fluid stream 101, typically a CO2 rich fluid, fuel stream 103, and oxidant stream 105 pass through valves 114, 116, and 118, respectively, which are normally open, into the pipes 191, 193, and 195. The fluids in these pipes is at a high pressure. They pass through these pipes, through ports 190, 192, and 194, respectively, and into the combustor 102 for combustion. The resultant heated fluid passes directly into turbo-expander 104, the energy being used to turn shaft 106, turning generator 108, generating power. During normal operations, switch 136 is closed, sending electrical power to power consumer 110. The heated fluid leaves the turbo-expander 104 as a low-pressure fluid into pipe 107, and is sent onward into the balance of the oxy-fuel combustions system 122 for cooling, compressing, and other normal unit operations. In normal operations, diverter valve 126 is closed.

Instruments 162 are constantly sending signals to controller 160. These may be physical instruments, virtual instruments created by machine learning algorithms, or both. Controller 160 may include any suitable combination of hardware (e.g., application specific integrated circuit (ASIC), field programmable gate array (FPGA), central processing unit (CPU), graphics process unit (GPU) or the like) and software (e.g., instructions causing the hardware to implement the functionality described herein). The instructions may be stored on a non-transitory computer-readable medium storing instructions to cause the processor to perform the steps of the present system. The circuitry between the controller 160 and the system 100 may be implemented using any suitable combination of hardware and software.

In the present example, switch 136 opening, thereby cutting off a load for the electrical power created by generator 108, results in an overspeed condition where shaft 106 and turbo-expander 104 can accelerate to unsafe speeds. This load rejection condition can result in damage or even destruction of the turbo-expander 104 and shaft 106. To prevent overspeed, the present system controls the speed of the turbo-expander 104. The controller 160 detects a condition where the turbo-expander 104 accelerates above a maximum acceleration, a maximum speed, or both. The controller 160 sends an open signal to diverter valve 126 and a close signal to valve 114, stopping flow of the working fluid into pipe 195. In some examples, the close signal also closes valves 116 and 118. The working fluid passes from pipe 195 through valve 126 and into the volume in pipe 107, which is at a lower pressure than pipe 195. Pipe 107 is therefore the discharge chamber. This reduces the pressure differential across the turbo-expander 104 to slow or even stop the rotation of the turbo-expander 104 and shaft 106. The amount of volume in pipe 107 can be selected to accept part or even all of the fluid from pipe 195 to reduce or even equalize the pressure differential. A lesser volume would reduce the pressure differential, reducing the rotation of the turbo-expander 104. A large enough volume would eliminate the pressure differential, stopping the rotation of the turbo-expander 104. In this example, the volume would be large enough to stop the rotation. In examples where a partial-load rejection occurs, a partial reduction would be acceptable.

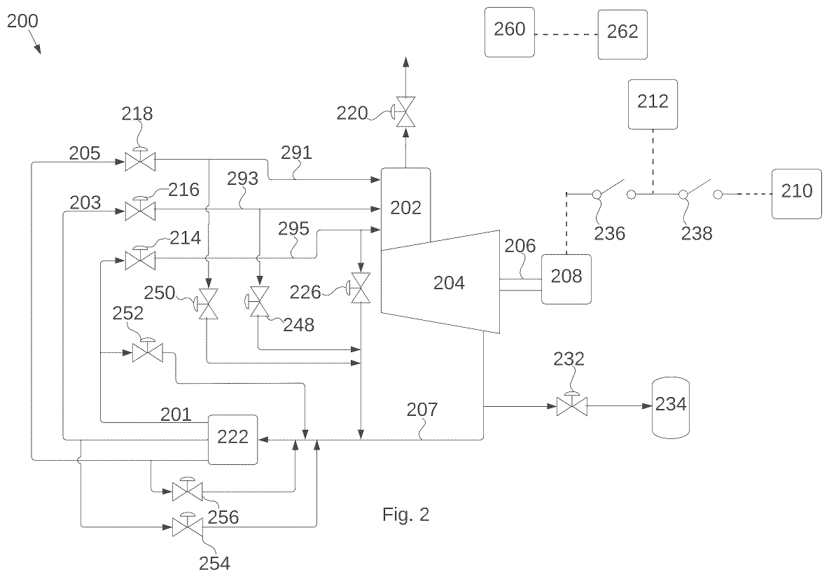

Now referring to FIG. 2, FIG. 2 is a process flow diagram showing another example system 200 for controlling the speed of a turbo-expander receiving a working fluid from an oxy-fuel combustor that may be used in some examples provided herein. This example is purely illustrative, and multiple other examples are envisioned or may be readily envisioned without undue experimentation.

In some examples, system 200 is an oxy-fuel combustion system for generating power. In the nonlimiting configuration illustrated in FIG. 2, system 200 includes a combustor 202, a turbo-expander 204, a shaft 206, a generator 208, a switch 236, a switch 238, a power consumer 210, a house load 212, the balance of the oxy-fuel combustion system 222, a controller 260, oxy-fuel combustion system instruments 262, a first diverter valve 226, a second diverter valve 248, a third diverter valve 250, a first pre-block diverter valve 252, a second pre-block diverter valve 254, a third pre-block diverter valve 256, a vent valve 220, a surge valve 232, a surge vessel 234, a working fluid valve 214, a fuel valve 216, an oxidant valve 218. The last three will be referred to as the first, second, and third valves, respectively. In normal operations, working fluid stream 201, typically a CO2 rich fluid, fuel stream 203, and oxidant stream 205 pass through valves 214, 216, and 218, respectively, which are normally open, into the pipes 291, 293, and 295. The fluids in these pipes is at a high pressure. They pass through these pipes, through ports 290, 292, and 294, respectively, and into the combustor 202 for combustion. The resultant heated fluid passes directly into turbo-expander 204, the energy being used to turn shaft 206, turning generator 208, generating power. During normal operations, switches 236 and 238 are closed, sending electrical power to power consumer 210. The heated fluid leaves the turbo-expander 204 as a low-pressure fluid into pipe 207, and is sent onward into the balance of the oxy-fuel combustions system 222 for cooling, compressing, and other normal unit operations. In normal operations, diverter valves 226, 248, and 250, pre-block diverter valves 252, 254, and 256, and vent valve 220 are closed.

Instruments 262 are constantly sending signals to controller 260. Controller 260 may include any suitable combination of hardware (e.g., application specific integrated circuit (ASIC), field programmable gate array (FPGA), central processing unit (CPU), graphics process unit (GPU) or the like) and software (e.g., instructions causing the hardware to implement the functionality described herein). The instructions may be stored on a non-transitory computer-readable medium storing instructions to cause the processor to perform the steps of the present system. The circuitry between the controller 260 and the system 200 may be implemented using any suitable combination of hardware and software.

In the present example, switch 238 opening while switch 236 remains closed, thereby cutting off a load for the electrical power created by generator 208, results in an overspeed condition where shaft 206 and turbo-expander 204 can accelerate to unsafe speeds. This load rejection condition can result in damage or even destruction of the turbo-expander 204 and shaft 206. To prevent overspeed, the present system controls the speed of the turbo-expander 204. The controller 260 detects a condition where the turbo-expander 204 accelerates above a maximum acceleration, a maximum speed, or both. The controller 260 sends an open signal to diverter valves 226, 248, and 250 and a close signal to valves 214, 216, and 218, stopping flow of the oxidant, the fuel, and the working fluid into pipes 291, 293, and 295, respectively. The working fluid passes from pipe 295 through valve 226 and into the volume in pipe 207, which is at a lower pressure than pipe 295. This reduces the pressure differential across the turbo-expander 204 to slow or even stop the rotation of the turbo-expander 204 and shaft 206. The amount of volume in pipe 207 can be selected to accept part or even all of the fluid from pipe 295 to reduce or even equalize the pressure differential. A lesser volume would reduce the pressure differential, reducing the rotation of the turbo-expander 204. A large enough volume would eliminate the pressure differential, stopping the rotation of the turbo-expander 204. In this example, the volume would be large enough to stop the rotation. In examples where a partial-load rejection occurs, a partial reduction would be acceptable.

In some examples, the reduction is insufficient and vent valve 220 is opened, venting the combustor to atmosphere, thereby eliminating the pressure differential across the turbo-expander 204.

In some examples, the reduction is insufficient due to the pipe 207 volume being too small to be the full discharge chamber. Surge valve 232 is opened and surge vessel 234 becomes extra volume for pressure differential reduction.

In some examples, closing valves 214, 216, and 218 abruptly can cause hammering. Valves 252, 254, and 256 are able to open as valves 214, 216, and 218 are closing, allowing the pressure to vent to the lower-pressure volume of pipe 207.

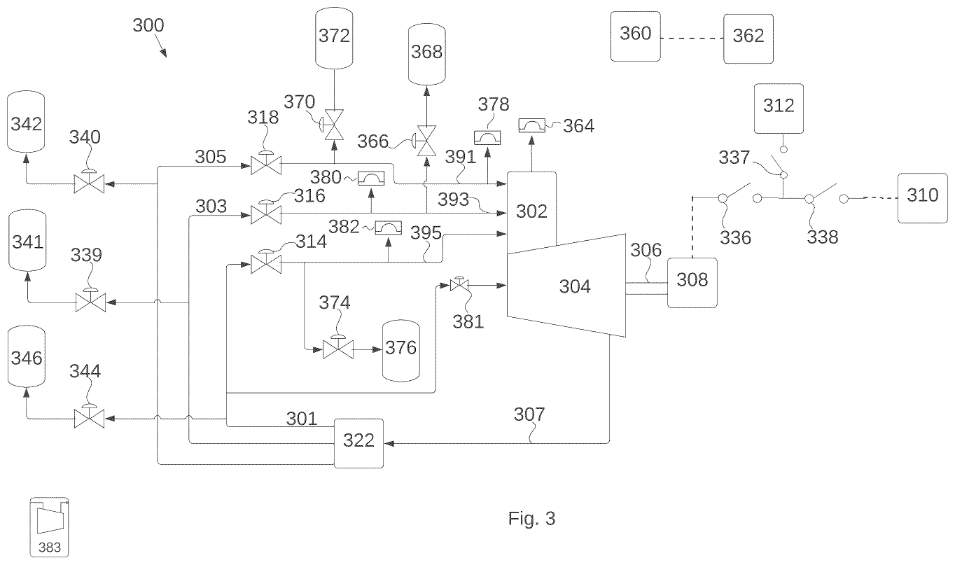

Now referring to FIG. 3, FIG. 3 is a process flow diagram showing another example system 300 for controlling the speed of a turbo-expander receiving a working fluid from an oxy-fuel combustor that may be used in some examples provided herein. This example is purely illustrative, and multiple other examples are envisioned or may be readily envisioned without undue experimentation.

In some examples, system 300 is an oxy-fuel combustion system for generating power. In the nonlimiting configuration illustrated in FIG. 3, system 300 includes a combustor 302, a turbo-expander 304, a shaft 306, a generator 308, a switch 336, a switch 337, a switch 338, a power consumer 310, a load bank 312, the balance of the oxy-fuel combustion system 322, a controller 360, oxy-fuel combustion system instruments 362, diverter valves 374, 366, and 370 into discharge chamber vessels 376, 368, and 372, rupture discs 378, 380, and 382, pre-block diverter valves 340, 339, and 344 into pre-block chambers 342, 341, and 346, a slip-stream valve 381, a vessel purge pump 383, a working fluid valve 314, a fuel valve 316, and an oxidant valve 318. The last three will be referred to as the first, second, and third valves, respectively. In normal operations, working fluid stream 301, typically a CO2 rich fluid, fuel stream 303, and oxidant stream 305 pass through valves 314, 316, and 318, respectively, which are normally open, into the pipes 391, 393, and 395. The fluids in these pipes is at a high pressure. They pass through these pipes, through ports 390, 392, and 394, respectively, and into the combustor 302 for combustion. The resultant heated fluid passes directly into turbo-expander 304, the energy being used to turn shaft 306, turning generator 308, generating power. During normal operations, switches 336 and 338 are closed, sending electrical power to power consumer 310, while switch 337 is open, preventing power flow to the load bank. The heated fluid leaves the turbo-expander 304 as a low-pressure fluid into pipe 307, and is sent onward into the balance of the oxy-fuel combustions system 322 for cooling, compressing, and other normal unit operations. In normal operations, diverter valve 326 is closed.

Instruments 362 are constantly sending signals to controller 360. Controller 360 may include any suitable combination of hardware (e.g., application specific integrated circuit (ASIC), field programmable gate array (FPGA), central processing unit (CPU), graphics process unit (GPU) or the like) and software (e.g., instructions causing the hardware to implement the functionality described herein). The instructions may be stored on a non-transitory computer-readable medium storing instructions to cause the processor to perform the steps of the present system. The circuitry between the controller 360 and the system 300 may be implemented using any suitable combination of hardware and software.

In the present example, switch 338 opening, thereby cutting off a load for the electrical power created by generator 308, results in an overspeed condition where shaft 306 and turbo-expander 304 can accelerate to unsafe speeds. This load rejection condition can result in damage or even destruction of the turbo-expander 304 and shaft 306. To prevent overspeed, the present system controls the speed of the turbo-expander 304. The controller 360 detects a condition where the turbo-expander 304 accelerates above a maximum acceleration, a maximum speed, or both. The controller 360 sends an open signal to diverter valve 374, 366, and 370, and a close signal to valves 314, 316, and 318, stopping flow of the working fluid, the fuel, and the oxidant into pipes 395, 393, and 391, respectively. The working fluid passes from pipe 395 through valve 374 and into the surge vessel 376 (a first discharge chamber), which is at a lower pressure than pipe 395. The fuel passes from pipe 393 through valve 366 and into the surge vessel 368 (a second discharge chamber), which is at a lower pressure than pipe 393. The oxidant passes from pipe 391 through valve 370 and into the surge vessel 372 (a third discharge chamber), which is at a lower pressure than pipe 391. This reduces the pressure differential across the turbo-expander 304 to slow or even stop the rotation of the turbo-expander 304 and shaft 306. The three surge vessels may also be a single surge vessel. The amount of volume in the surge vessels 376, 368, and 372 can be selected to accept part or even all of the fluid from pipes 395, 393, and 391 to reduce or even equalize the pressure differential. A lesser volume would reduce the pressure differential, reducing the rotation of the turbo-expander 304. A large enough volume would eliminate the pressure differential, stopping the rotation of the turbo-expander 304. In this example, the volume would be large enough to stop the rotation. In examples where a partial-load rejection occurs, a partial reduction would be acceptable.

In this example, switch 337 can close during the load rejection even, passing power into load bank 312, mitigating the load rejection event, providing extra time for pressure differential reduction.

In this example, rupture discs 364, 382, 380, or 378 are designed to rupture if the pressure passes above an emergency level, and vent to atmosphere, thereby neutralizing the pressure differential.

In some examples, closing valves 314, 316, and 318 abruptly can cause hammering. Valves 344, 339, and 340 are able to open as valves 314, 316, and 318 are closing, allowing the pressure to vent to the lower-pressure volume of vessels 346, 341, and 342, respectively.

In some examples, pumps or compressors 383 is used to remove fluids from vessels 341, 342, 346, 376, 372, and 368 to reset them to low pressure.

In some examples, a slip stream valve 381 creates a slip stream of the working fluid stream to bypass the working fluid stream valve 314 and cool the turbo-expander during any load rejection event.

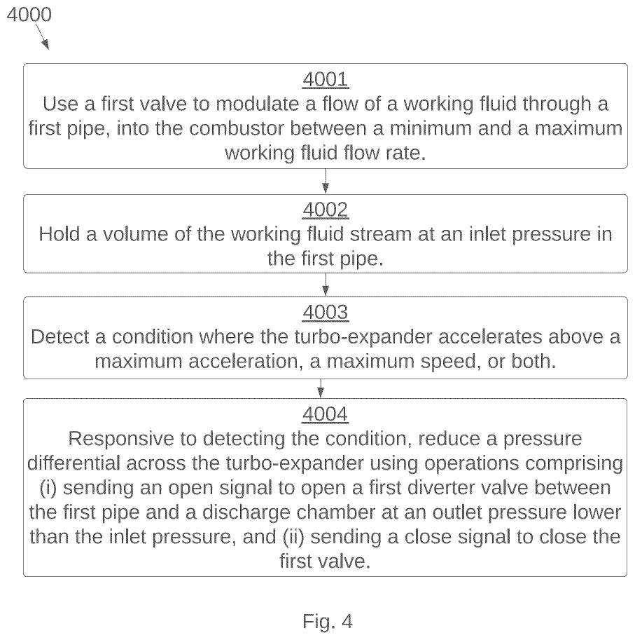

Illustratively, FIG. 4 is a block diagram showing an example method 4000 for controlling the speed of a turbo-expander receiving a working fluid from an oxy-fuel combustor that may be used in some examples provided herein. The method reduces the pressure differential across the turbo-expander during a load rejection event or other event where the turbo-expander accelerates past a safe maximum or reaches a speed above a maximum. While method 4000 optionally may be implemented using system 100, 200, or 300, it will be appreciated that any other suitable combination of components may be used to implement method 4000.

Method 4000 illustrated in FIG. 4 may include using a first valve to modulate the flow of a working fluid through a first pipe, into the combustor between a minimum and a maximum working fluid flow rate (operation 4001). For example, in a manner such as described above with reference to FIG. 1, controller 160 may modulate first valve 114 to pass working fluid 101 through first pipe 195 into the combustor 102 between the minimum and maximum flow rates required.

Referring again to FIG. 4, method 4000 may also include holding a volume of the working fluid stream at an inlet pressure in the first pipe (operation 4002). For example, in a manner such as described above with reference to FIG. 1, first pipe 195 holds a volume of the working fluid stream at an inlet pressure. A discharge chamber 107 is at an outlet pressure that is lower than the inlet pressure.

Referring again to FIG. 4, method 4000 may also include detecting a condition where the turbo-expander accelerates above a maximum acceleration, a maximum speed, or both (operation 4003). For example, in a manner such as described above with reference to FIG. 1, instruments 162 detect a condition where the turbo-expander accelerates above a maximum acceleration, a maximum speed, or both, and passes this information to a controller 160.

Referring again to FIG. 4, method 4000 may also include, responsive to detecting the condition, reducing a pressure differential across the turbo-expander using operations comprising, (i) sending an open signal to open a first diverter valve between the first pipe and the discharge chamber at an outlet pressure lower than the inlet pressure, and (ii) sending a close signal to close the first valve (operation 4004). For example, in a manner such as described above with reference to FIG. 1, the open signal reaches the first diverter valve 126, which opens a fluid path between the first pipe 195 and the discharge chamber in pipe 107. The close signal reaches the first valve 114, closing off further working fluid entering pipe 195. As the working fluid in pipe 195 travels to the discharge chamber 107 due to the pressure gradient, the pressure differential across the turbo-expander is controlled, mitigating the danger of overspeed for the turbo-expander 104.

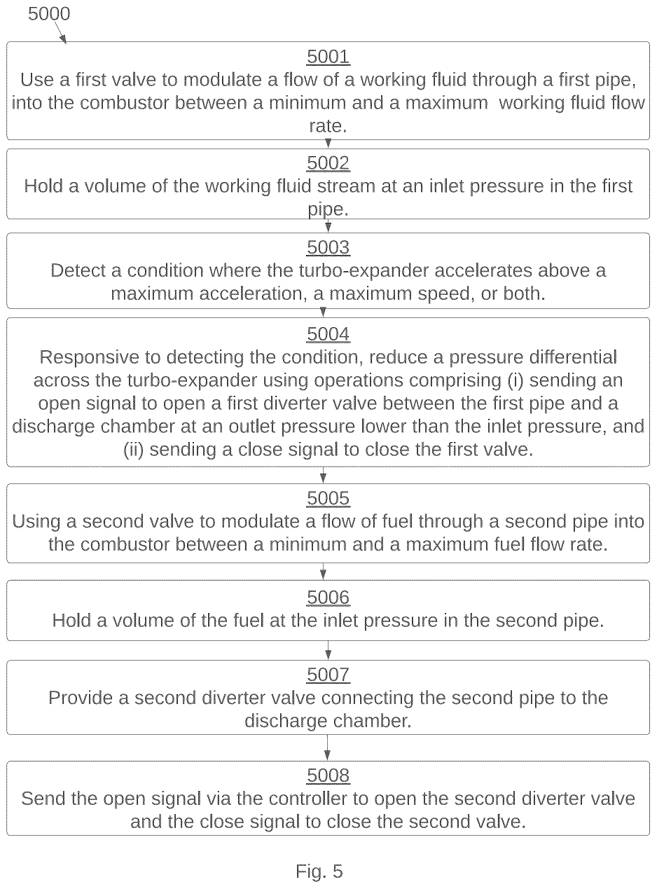

Illustratively, FIG. 5 is a block diagram showing an example method 5000 for controlling the speed of a turbo-expander receiving a working fluid from an oxy-fuel combustor that may be used in some examples provided herein. The method reduces the pressure differential across the turbo-expander during a load rejection event or other event where the turbo-expander accelerates past a safe maximum or reaches a speed above a maximum. While method 5000 optionally may be implemented using system 100, 200, or 300, it will be appreciated that any other suitable combination of components may be used to implement method 5000.

Method 5000 illustrated in FIG. 5 may include using a first valve to modulate the flow of a working fluid through a first pipe, into the combustor between a minimum and a maximum working fluid flow rate (operation 5001). For example, in a manner such as described above with reference to FIG. 2, controller 260 may modulate first valve 214 to pass working fluid 201 through first pipe 295 into the combustor 202 between the minimum and maximum flow rates required.

Referring again to FIG. 5, method 5000 may also include holding a volume of the working fluid stream at an inlet pressure in the first pipe (operation 5002). For example, in a manner such as described above with reference to FIG. 2, first pipe 295 holds a volume of the working fluid stream at an inlet pressure. A discharge chamber 207 is at an outlet pressure that is lower than the inlet pressure.

Referring again to FIG. 5, method 5000 may also include detecting a condition where the turbo-expander accelerates above a maximum acceleration, a maximum speed, or both (operation 5003). For example, in a manner such as described above with reference to FIG. 2, instruments 262 detect a condition where the turbo-expander accelerates above a maximum acceleration, a maximum speed, or both, and passes this information to a controller 260.

Referring again to FIG. 5, method 5000 may also include, responsive to detecting the condition, reducing a pressure differential across the turbo-expander using operations comprising, (i) sending an open signal to open a first diverter valve between the first pipe and the discharge chamber at an outlet pressure lower than the inlet pressure, and (ii) sending a close signal to close the first valve (operation 5004). For example, in a manner such as described above with reference to FIG. 2, the open signal reaches the first diverter valve 226, which opens a fluid path between the first pipe 295 and the discharge chamber in pipe 207. The close signal reaches the first valve 214, closing off further working fluid entering pipe 295. As the working fluid in pipe 295 travels to the discharge chamber 207 due to the pressure gradient, the pressure differential across the turbo-expander is controlled, mitigating the danger of overspeed for the turbo-expander 204.

Referring again to FIG. 5, method 5000 may also include using a second valve to modulate a flow of a fuel stream through a second pipe into the combustor between a minimum and a maximum fuel flow rate (operation 5005). For example, in a manner such as described above with reference to FIG. 2, controller 260 may modulate second valve 216 to pass fuel 203 through second pipe 293 into the combustor 202 between the minimum and maximum flow rates required.

Referring again to FIG. 5, method 5000 may also include holding a volume of the fuel stream at the inlet pressure in the second pipe (operation 5006). For example, in a manner such as described above with reference to FIG. 2, second pipe 293 holds a volume of the fuel stream at the inlet pressure.

Referring again to FIG. 5, method 5000 may also include providing a second diverter valve connecting the second pipe to the discharge chamber (operation 5007). For example, in a manner such as described above with reference to FIG. 2, the second diverter valve 216 connects the second pipe 293 to the chamber 207.

Referring again to FIG. 5, method 5000 may also include, responsive to detecting the condition, sending the open signal via the controller to open the second diverter valve and the close signal to close the second valve, thereby reducing the pressure differential across the turbo-expander (operation 5008). For example, in a manner such as described above with reference to FIG. 2, the open signal reaches the second diverter valve 248, which opens a fluid path between the second pipe 293 and the discharge chamber in pipe 207. The close signal reaches the second valve 216, closing off further fuel entering pipe 295. As the fuel in pipe 293 travels to the discharge chamber 207 due to the pressure gradient, the pressure differential across the turbo-expander is controlled, mitigating the danger of overspeed for the turbo-expander 204.

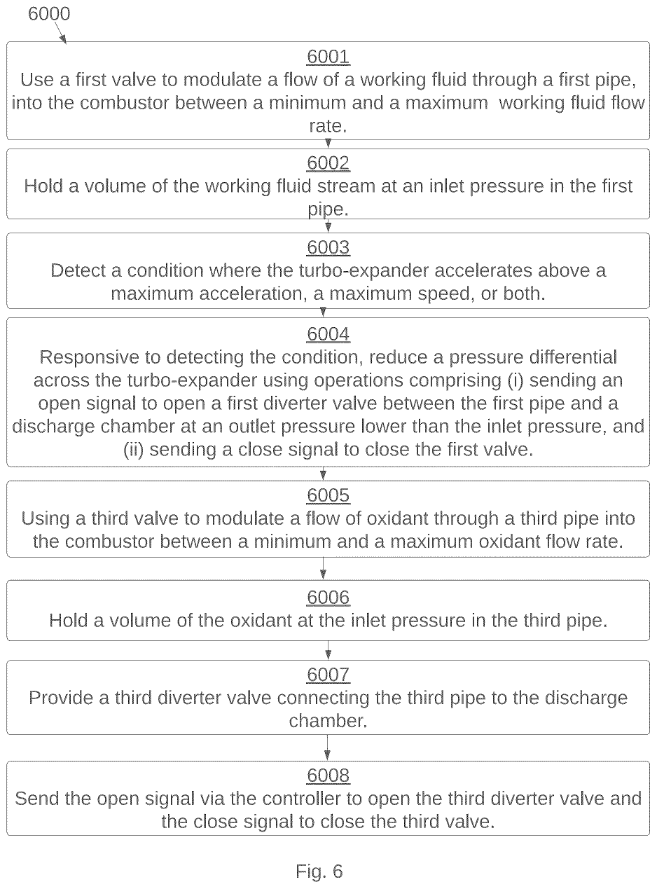

Illustratively, FIG. 6 is a block diagram showing an example method 6000 for controlling the speed of a turbo-expander receiving a working fluid from an oxy-fuel combustor that may be used in some examples provided herein. The method reduces the pressure differential across the turbo-expander during a load rejection event or other event where the turbo-expander accelerates past a safe maximum or reaches a speed above a maximum. While method 6000 optionally may be implemented using system 100, 200, or 300, it will be appreciated that any other suitable combination of components may be used to implement method 6000.

Method 6000 illustrated in FIG. 6 may include using a first valve to modulate the flow of a working fluid through a first pipe, into the combustor between a minimum and a maximum working fluid flow rate (operation 6001). For example, in a manner such as described above with reference to FIG. 2, controller 260 may modulate first valve 214 to pass working fluid 201 through first pipe 295 into the combustor 202 between the minimum and maximum flow rates required.

Referring again to FIG. 6, method 6000 may also include holding a volume of the working fluid stream at an inlet pressure in the first pipe (operation 6002). For example, in a manner such as described above with reference to FIG. 2, first pipe 295 holds a volume of the working fluid stream at an inlet pressure. A discharge chamber 207 is at an outlet pressure that is lower than the inlet pressure.

Referring again to FIG. 6, method 6000 may also include detecting a condition where the turbo-expander accelerates above a maximum acceleration, a maximum speed, or both (operation 6003). For example, in a manner such as described above with reference to FIG. 2, instruments 262 detect a condition where the turbo-expander accelerates above a maximum acceleration, a maximum speed, or both, and passes this information to a controller 260.

Referring again to FIG. 6, method 6000 may also include, responsive to detecting the condition, reducing a pressure differential across the turbo-expander using operations comprising, (i) sending an open signal to open a first diverter valve between the first pipe and the discharge chamber at an outlet pressure lower than the inlet pressure, and (ii) sending a close signal to close the first valve (operation 6004). For example, in a manner such as described above with reference to FIG. 2, the open signal reaches the first diverter valve 226, which opens a fluid path between the first pipe 295 and the discharge chamber in pipe 207. The close signal reaches the first valve 214, closing off further working fluid entering pipe 295. As the working fluid in pipe 295 travels to the discharge chamber 207 due to the pressure gradient, the pressure differential across the turbo-expander is controlled, mitigating the danger of overspeed for the turbo-expander 204.

Referring again to FIG. 6, method 6000 may also include using a third valve to modulate a flow of an oxidant stream through a third pipe into the combustor between a minimum and a maximum oxidant flow rate (operation 6005). For example, in a manner such as described above with reference to FIG. 2, controller 260 may modulate third valve 218 to pass oxidant 205 through third pipe 291 into the combustor 202 between the minimum and maximum flow rates required.

Referring again to FIG. 6, method 6000 may also include holding a volume of the oxidant stream at the inlet pressure in the third pipe (operation 6006). For example, in a manner such as described above with reference to FIG. 2, third pipe 291 holds a volume of the oxidant stream at the inlet pressure.

Referring again to FIG. 6, method 6000 may also include providing a third diverter valve connecting the third pipe to the discharge chamber (operation 6007). For example, in a manner such as described above with reference to FIG. 2, the third diverter valve 218 connects the third pipe 291 to the chamber 207.

Referring again to FIG. 6, method 6000 may also include, responsive to detecting the condition, sending the open signal via the controller to open the third diverter valve and the close signal to close the third valve, thereby reducing the pressure differential across the turbo-expander (operation 6008). For example, in a manner such as described above with reference to FIG. 2, the open signal reaches the third diverter valve 250, which opens a fluid path between the third pipe 291 and the discharge chamber in pipe 207. The close signal reaches the third valve 218, closing off further oxidant entering pipe 295. As the oxidant in pipe 291 travels to the discharge chamber 207 due to the pressure gradient, the pressure differential across the turbo-expander is controlled, mitigating the danger of overspeed for the turbo-expander 204.

All patents and published patent applications referred to herein are incorporated herein by reference in their entireties. The invention has been described with reference to various specific and preferred embodiments and techniques. Nevertheless, it is understood that many variations and modifications may be made while remaining within the spirit and scope of the invention.

What is claimed is:

1. A system for controlling a speed of a turbo-expander receiving a working fluid from an oxy-fuel combustor, the system comprising:
a first valve to modulate a flow, through a first port, of the working fluid into the oxy-fuel combustor between a minimum working fluid flow rate and a maximum working fluid flow rate;
a first pipe between the first valve and the first port, the first pipe comprising a first volume to hold the working fluid at an inlet pressure of the oxy-fuel combustor;
a discharge chamber to receive at least a portion of the working fluid, the discharge chamber at an outlet pressure lower than the inlet pressure;
a first diverter valve to connect the first pipe and the discharge chamber when the first diverter valve is open; and
a controller to:
(i) detect a first condition where the turbo-expander accelerates above a maximum acceleration, above a maximum speed, or above both a maximum acceleration and above a maximum speed, and
(ii) responsive to detecting the first condition, reduce a pressure differential across the turbo-expander by sending an open signal to open the diverter valve and sending a close signal to close the first valve.

2. The system of claim 1, further comprising the turbo-expander and a generator, wherein the turbo-expander is to drive the generator.

3. The system of claim 2, wherein the controller is to control the speed of the turbo-expander during a load rejection event.

4. The system of claim 3, further comprising a house load to receive a first portion of a power output of the generator during the load rejection event.

5. The system of claim 4, further comprising a load bank to receive a second portion of the power output of the generator during the load rejection event.

6. The system of claim 1, further comprising a backup first diverter valve to provide redundancy to the first diverter valve.

7. The system of claim 1, further comprising a first pre-block diverter valve connected upstream of the first valve to the discharge chamber, the open signal further to open the first pre-block diverter valve as the first valve is closed.

8. The system of claim 7, further comprising a second pre-block diverter valve connected upstream of the first valve to a low-pressure chamber, the open signal further to open the second pre-block diverter valve as the first valve is closed.

9. The system of claim 8, further comprising a first rupture disc between the first pipe and the discharge chamber to rupture when the pressure differential exceeds a first safety limit.

10. The system of claim 9, wherein the controller further is to (iii) detect a second condition where the turbo-expander acceleration approaches the maximum acceleration, approaches the maximum speed, or approaches both the maximum acceleration and the maximum speed, and (iv) send a second signal to partially close the first valve, partially open the first diverter valve, or both partially close the first valve and partially open the diverter valve.

11. The system of claim 10, further comprising:
a second valve to modulate a flow, through a second port, of fuel into the oxy-fuel combustor between a minimum fuel flow rate and a maximum fuel flow rate;
a second pipe between the second valve and the second port, the second pipe comprising a second volume to hold the fuel at the inlet pressure; and
a second diverter valve to connect the second pipe and the discharge chamber when the second diverter valve is open;
wherein the open signal further is to open the second diverter valve and the close signal further is to close the second valve, thereby reducing the pressure differential.

12. The system of claim 11, further comprising a backup second diverter valve to provide redundancy to the second diverter valve.

13. The system of claim 12, further comprising a third pre-block diverter valve connected upstream of the second valve to the discharge chamber, the open signal further to open the third pre-block diverter valve as the second valve is closed.

14. The system of claim 13, further comprising a fourth pre-block diverter valve connected upstream of the second valve to a low-pressure chamber, the open signal further to open the fourth pre-block diverter valve as the second valve is closed.

15. The system of claim 14, further comprising a second rupture disc between the second pipe and the discharge chamber to rupture when the pressure differential exceeds a second safety limit.

16. The system of claim 15, wherein the controller further is to (v) detect a third condition where the turbo-expander acceleration approaches the maximum acceleration, approaches the maximum speed, or approaches both the maximum acceleration and the maximum speed, and (vi) send a third signal to partially close the second valve, partially open the second diverter valve, or to both partially close the second valve and partially open the second diverter valve.

17. The system of claim 16, further comprising:
a third valve to modulate a flow, through a third port, of an oxidant into the oxy-fuel combustor between a minimum oxidant flow rate and a maximum oxidant flow rate;
a third pipe between the third valve and the third port, the third pipe comprising a third volume to hold the oxidant at the inlet pressure;
a third diverter valve to connect the third pipe and the discharge chamber when the third diverter valve is open; and
the open signal further to open the third diverter valve and the close signal further to close the second valve, thereby reducing the pressure differential.

18. The system of claim 17, further comprising a backup third diverter valve to provide redundancy to the third diverter valve.

19. The system of claim 17, further comprising a fifth pre-block diverter valve connected upstream of the third valve to the discharge chamber, the open signal further to open the fifth pre-block diverter valve as the third valve is closed.

20. The system of claim 19, further comprising a sixth pre-block diverter valve connected upstream of the third valve to a low-pressure chamber, the open signal further to open the sixth pre-block diverter valve as the third valve is closed.

21. The system of claim 17, further comprising a third rupture disc between the third piped connection and the discharge chamber to rupture when the pressure differential exceeds a safety limit.

22. The system of claim 17, further comprising the controller to detect a fourth condition where the turbo-expander acceleration approaches the maximum acceleration, approaches the maximum speed, or both, and the controller to send a fourth signal to partially close the third valve, partially open the third diverter valve, or both partially close the third valve and partially open the third diverter valve.

23. The system of claim 1, wherein the discharge chamber comprises a post-turbo-expander volume.

24. The system of claim 1, wherein the discharge chamber comprises a pressure vessel.

25. The system of claim 24, further comprising a pump to maintain the pressure vessel at a lower pressure than the inlet pressure before the controller detects the condition.

26. The system of claim 1, further comprising a vent valve in fluid communication with a volume of the oxy-fuel combustor, the controller further to determine whether a rate of decrease of the pressure differential is insufficient, and responsive to determining that the rate of decrease of the pressure differential is insufficient, send a second open signal to the vent valve, the vent valve to vent the working fluid from the oxy-fuel combustor.

27. The system of claim 1, further comprising a power-load imbalance detector to signal the controller, the controller further to send the open signal and the close signal if a detected imbalance is above a threshold.

28. The system of claim 1, further comprising instruments, virtual instruments, or both instruments and virtual instruments, to detect the first condition.

29. The system of claim 1, further comprising a slip stream valve to create a slip stream of the working fluid to bypass the first valve and cool the turbo-expander.

30. A method for controlling a speed of a turbo-expander receiving a working fluid from an oxy-fuel combustor, the method comprising:
using a first valve to modulate a flow of the working fluid through a first pipe, into the oxy-fuel combustor between a minimum working fluid flow rate and a maximum working fluid flow rate;
holding a volume of the working fluid at an inlet pressure in the first pipe;
detecting a condition where the turbo-expander accelerates above a maximum acceleration, above a maximum speed, or above both a maximum acceleration and a maximum speed; and
responsive to detecting the condition, reducing a pressure differential across the turbo-expander using operations comprising:
(i) sending an open signal to open a first diverter valve between the first pipe and a discharge chamber at an outlet pressure lower than the inlet pressure, and
(ii) sending a close signal to close the first valve.

31. The method of claim 30, further comprising driving a generator by the turbo-expander.

32. The method of claim 31, further comprising controlling the speed of the turbo-expander during a load rejection event.

33. The method of claim 32, further comprising receiving a first portion of a power output of the generator in a house load during the load rejection event.

34. The method of claim 33, further comprising receiving a second portion of the power output of the generator in a load bank during the load rejection event.

35. The method of claim 30, further comprising opening a backup first diverter valve by a backup open signal when the first diverter valve fails.

36. The method of claim 30, wherein a first pre-block diverter valve is connected upstream of the first valve to the discharge chamber, and further comprising opening the first pre-block diverter valve by a backpressure-prevention open signal as the first valve is closed.

37. The method of claim 35, wherein a second pre-block diverter valve is connected upstream of the first valve to a low-pressure chamber, and further comprising opening the second pre-block diverter valve by a backpressure-prevention open signal from the controller as the first valve is closed.

38. The method of claim 37, wherein a first rupture disc is between the first pipe and the discharge chamber, the first rupture disc rupturing when the pressure differential exceeds a safety limit.

39. The method of claim 38, further comprising detecting a second condition where the turbo-expander acceleration approaches the maximum acceleration, the turbo-expander approaches the maximum speed, or both the turbo-expander acceleration approaches the maximum acceleration and the turbo-expander approaches maximum speed, and sending a first signal to partially close the first valve, partially open the first diverter valve, or both partially close the first valve and partially open the first diverter valve.

40. The method of claim 39, further comprising:
using a second valve to modulate a flow of a fuel through a second pipe, into the oxy-fuel combustor between a minimum fuel flow rate and a maximum fuel flow rate;
holding a volume of the fuel at the inlet pressure in the second pipe; and
responsive to detecting the condition:
(i) sending the open signal to open a second diverter valve between the second pipe and the discharge chamber, the second pipe at the inlet pressure, and
(ii) sending the close signal to close the second valve.

41. The method of claim 40, further comprising opening a backup second diverter valve by the backup open signal when the second diverter valve fails.

42. The method of claim 41, wherein a third pre-block diverter valve is connected upstream of the second valve to the discharge chamber, and further comprising opening the third pre-block diverter valve by the backpressure-prevention open signal as the second valve is closed.

43. The method of claim 42, wherein a fourth pre-block diverter valve is connected upstream of the second valve to a low-pressure chamber, and further comprising opening the fourth pre-block diverter valve by the backpressure-prevention open signal as the second valve is closed.

44. The method of claim 43, wherein a second rupture disc is between the second pipe and the discharge chamber, the second rupture disc rupturing when the pressure differential exceeds a safety limit.

45. The method of claim 44, wherein the second signal partially closes the second valve, partially opens the second diverter valve, or both partially closes the second valve and partially opens the second diverter valve.

46. The method of claim 45, further comprising:
using a third valve to modulate a flow of an oxidant through a third pipe, into the oxy-fuel combustor, between a minimum oxidant flow rate and a maximum oxidant flow rate;
holding a volume of the oxidant stream at the inlet pressure in the third pipe;
wherein a third diverter valve connects the third pipe to the discharge chamber; and
responsive to detecting the condition:
(i) sending an open signal to open a third diverter valve connecting the third pipe to the discharge chamber, the third pipe at the inlet pressure, and
(ii) sending a close signal via the controller to close the third valve.

47. The method of claim 46, further comprising opening a backup third diverter valve by the backup open signal when the third diverter valve fails.

48. The method of claim 46, wherein a fifth pre-block diverter valve is connected upstream of the third valve to the discharge chamber, and further comprising opening the fifth pre-block diverter valve by a backpressure-prevention open signal as the third valve is closed.

49. The method of claim 48, wherein a sixth pre-block diverter valve is connected upstream of the third valve to a low-pressure chamber, and further comprising opening the sixth pre-block diverter valve by the backpressure-prevention open signal as the third valve is closed.

50. The method of claim 46, wherein a rupture disc is between the third pipe and the discharge chamber, the rupture disc rupturing when the pressure differential exceeds a safety limit.

51. The method of claim 46, further comprising the second signal partially closing the third valve, partially opening the third diverter valve, or both partially closing the third valve and partially opening the third diverter valve.

52. The method of claim 30, wherein the discharge chamber comprises a post-turbo-expander volume.

53. The method of claim 30, wherein the discharge chamber comprises a pressure vessel.

54. The method of claim 53, further comprising maintaining the pressure vessel at a lower pressure than the first piped connection by a pump before detecting the condition.

55. The method of claim 30, wherein a vent valve is in fluid communication with the oxy-fuel combustor volume, further comprising determining a rate of decrease of the pressure differential is insufficient, sending an emergency open signal to open the vent valve, and venting the combusting gas from the combustor via the vent valve.

56. The method of claim 30, further comprising sending a power-load imbalance signal from a power-load imbalance detector, responding to a detected imbalance above a threshold by sending the open signal and the close signal.

57. The method of claim 30, further comprising detecting the condition with instruments, virtual instruments, or both instruments and virtual instruments.

58. The method of claim 30, further comprising a slip stream of the working fluid, and further comprising bypassing the working fluid valve with the slip stream, and using the slip stream to cool the turbo-expander.

59. A system for preventing overspeed of a turbo-expander, comprising:
an oxy-fuel combustor system comprising a first pre-combustor volume containing a working fluid stream, a second pre-combustor volume containing an oxidant stream, and a third pre-combustor volume containing a fuel stream, all connected to a combustor volume containing a combusting gas stream, the combustor volume connected to a turbo-expander volume containing a hot working fluid stream, wherein the oxy-fuel combustor system is configured to drive rotation of a shaft to drive a generator, wherein the pre-combustor volume is at a greater pressure than a dump volume, and wherein the dump volume is enclosed;
a working fluid cut-off valve configured to control flow of the working fluid stream into the first pre-combustor volume;
an oxidant cut-off valve configured to control flow of the oxidant stream into a second pre-combustor volume;
a fuel cut-off valve configured to control flow of the fuel stream into a third pre-combustor volume;
a first bypass valve configured to control flow of a working fluid vent stream from the first pre-combustor volume into the dump volume; and
a controller configured to detect a load rejection and send a close signal to the working fluid cut-off valve, the fuel cut-off valve, and the oxidant cut-off valve to close, and send an open signal to the first bypass valve to open such that the working fluid is vented from the first pre-combustor volume to the dump volume, reducing a rotation speed of the shaft.

60. A method for preventing overspeed of a turbo-expander powered generator during load rejection, comprising:
passing a working fluid stream through a working fluid cut-off valve, through a first pre-combustor volume, and into a combustor volume;
passing an oxidant stream through an oxidant cut-off valve, through a second pre-combustor volume, and into the combustor volume;
passing a fuel stream through a fuel cut-off valve, through a third pre-combustor volume, and into the combustor volume;
mixing and combusting the working fluid stream, the oxidant stream, and the fuel stream in the combustor volume to create a hot working fluid stream;
driving a turbine with the hot working fluid stream, the turbine driving a shaft at a rotation speed, the shaft driving a generator, and the generator generating electrical power;
detecting a load rejection of the electrical power and sending an upset signal to a controller;
sending a close signal from the controller to the working fluid cut-off valve, the oxidant cut-off valve, and the fuel cut-off valve;
sending an open signal from the controller to a first bypass valve, the first bypass valve connecting the first pre-combustor volume to a dump volume, wherein the dump volume is at a lower pressure than the combustor volume; and
venting the working fluid stream through the first bypass valve into the dump volume, reducing the rotation speed.

61. A system for preventing overspeed of a turbo-expander, comprising:
an oxy-fuel combustor comprising a combustion output that provides a working fluid to a turbo-expander, where the combustor further comprising a fuel stream input port, an oxidant stream input port, and a working fluid stream input port
where each of the fuel stream, the oxidant stream, and the working fluid stream ports are connected to a corresponding valve, such that the fuel stream valve, the oxidant stream valve, and the working fluid stream valve can modulate the flow of the respective fuel, oxidant, and working fluid streams entering the respective port between a minimum and maximum flow rate,
and where a first piped connection between the working fluid stream valve and the working fluid stream port holds a volume of the working fluid stream;
and where a second piped connection between the fuel stream valve and the fuel stream port holds a volume of the fuel stream;
and where a third piped connection between the oxidant stream valve and the oxidant stream port holds a volume of the oxidant stream;
wherein a pressure of the working fluid in the first piped connection prior to entry into the working fluid port is higher than a pressure at a discharge chamber;
further comprising a diverter valve between the first piped connection and the discharge chamber where a controller detects a condition where the turbo-expander accelerates above a maximum acceleration, a maximum speed, or both, and the controller opens the diverter valve as the working fluid stream valve is closed, thereby reducing a pressure differential across the turbo-expander.

62. A method for preventing overspeed of a turbo-expander, comprising:
providing an oxy-fuel combustor comprising a combustion output providing a working fluid to a turbo-expander, the oxy-fuel combustor further comprising a fuel stream input port, an oxidant stream input port, and a working fluid stream input port;
modulating a flow of a fuel stream through the fuel stream input port via a fuel stream valve;
modulating a flow of an oxidant stream through the oxidant stream input port via an oxidant stream valve;
modulating a flow of a working fluid stream through the working fluid stream port via a working fluid stream valve;
where the flows of the fuel stream, the oxidant stream, and the working fluid stream enter their respective port between a minimum and a maximum flow rate;
and where a first piped connection between the working fluid stream valve and the working fluid stream port holds a volume of the working fluid stream;
and where a second piped connection between the fuel stream valve and the fuel stream port holds a volume of the fuel stream;
and where a third piped connection between the oxidant stream valve and the oxidant stream port holds a volume of the oxidant stream;
wherein a pressure of the working fluid in the first piped connection prior to entry into the working fluid port is higher than a pressure at a discharge chamber;
detecting a condition where the turbo-expander accelerates above a maximum acceleration, a maximum speed, or both, in a controller; and
sending a signal via the controller to the diverter valve to open and the working fluid stream valve to close, thereby reducing a pressure differential across the turbo-expander.
